(19) United States
(12) Patent Application Publication
(10) Pub. No.: US 2007/0260764 A1
(43) Pub. Date: Nov. 8, 2007

(54) SEMI-AUTOMATIC TOKEN GENERATED ADDRESSING

(75) Inventors: Paul L. Summers, Troy, OH (US); Thomas E. Clary, Springfield, OH (US); Brian B. Garber, Fairborn, OH (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/279,189

(22) Filed: Apr. 10, 2006

(51) Int. Cl. G06F 3/00

(52) U.S. Cl. 710/9

(57) ABSTRACT

Systems and methods for assigning addresses to one or more components, such as luminaires, in a network. In one example the luminaires include one or more lamp sub-modules. An example method sends an address command from a master control unit to all luminaires over a communication broadcast databus, and switches the one or more luminaires to an addressing mode of operation based on the sent address command. A token signal is sent on a second serial databus to the one or more luminaires and address information is sent on the communication databus. The address information is recorded at the one or more luminaires based on the received token signal. Addresses are automatically assigned to the associated lamp sub-modules based on physical location and the recorded address information and assigned lamp sub-module addresses are sent to the master control unit. The sent address information and lamp sub-module addresses are saved.

### BACKGROUND OF THE INVENTION

There exist various methods for automatically generating and assigning addresses for components of an integrated network. However, if the components of the network include subcomponents that are not directly connect to a network control device, no method exists to easily/automatically assign an address to the subcomponents that also determines their physical location. Because of this limitation, the subcomponents fail to be easily interchanged within the system network without having to manually reassign address information to the components and the subcomponents.

Therefore, there exists a need for improving the interchangeability of components and subcomponents in a system network.

### SUMMARY OF THE INVENTION

The present invention provides systems and methods for assigning addresses to one or more components, such as luminaires, in a network. In one example the luminaires include one or more lamp modules. An example method sends a first message from a master control unit to all the luminaires on a broadcast databus, and switches all the luminaires to an addressing mode of operation when they receive this message. A token signal exists between each of the luminaires and is used to select the luminaire on the broadcast databus that responds to the addressing information. The address information is recorded at the luminaires selected by the received token signal. Addresses are assigned to the associated lamp modules and the recorded address information and assigned lamp module addresses are sent to the master control unit. The sent address information and lamp module addresses are stored in non-volatile memory in a system controller, and a luminaire controller.

In one aspect of the invention, the luminaire includes two or more locations having a unique configuration of one or more plug-in pins. Each of the locations is associated with an address known by the luminaire based on the configuration. The lamp modules are attached to a respective configuration of plug-in pins and corresponding physical locations.

### BRIEF DESCRIPTION OF THE DRAWINGS

The preferred and alternative embodiments of the present invention are described in detail below with reference to the following drawings:

FIGS. 1-3 illustrate block diagrams of components of the system formed in accordance with the embodiment of the present invention;

FIG. 4 illustrates an example process performed by the components shown in FIGS. 1-3;

FIG. 5 illustrates a particular example formed in accordance with the embodiment of the present invention; and

FIGS. 6A and 6B illustrate an addressing scheme for effectively delivering commands or instructions to luminaires and their associated sublamp modules.

### DETAILED DESCRIPTION OF THE PREFERRED EMBODIMENT

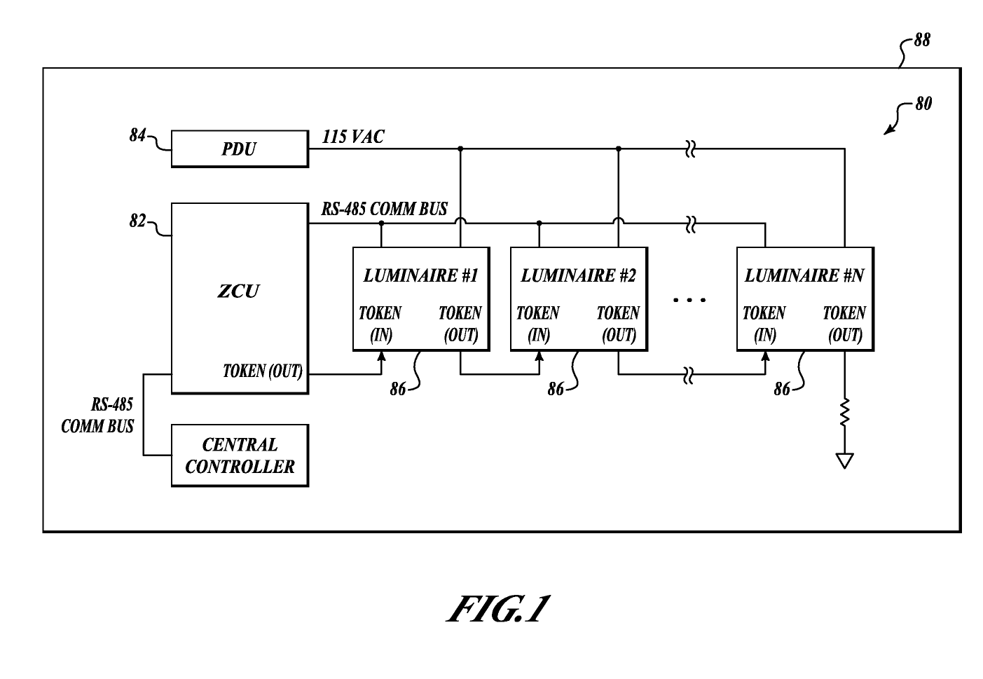

As shown in FIG. 1, an example system 80 performs automated address assignments for a plurality of luminaires 86 that receive power from a Power Distribution Unit (PDU) 84, and information from a Zone Control Unit (ZCU) 82. The ZCU 82 automatically assigns addresses to each of the luminaires 86 using a token signal sent over a token line and address information sent over a broadcast databus, such as an RS-485 communication databus. The luminaires 86 are separately addressable elements with at least some of the luminaires 86 having one or more sublight/lamp modules. In one embodiment, one or more system(s) 80 reside(s) in a cabin of an aircraft 88, but could be used anywhere luminaire and light module interchangeability is desired.

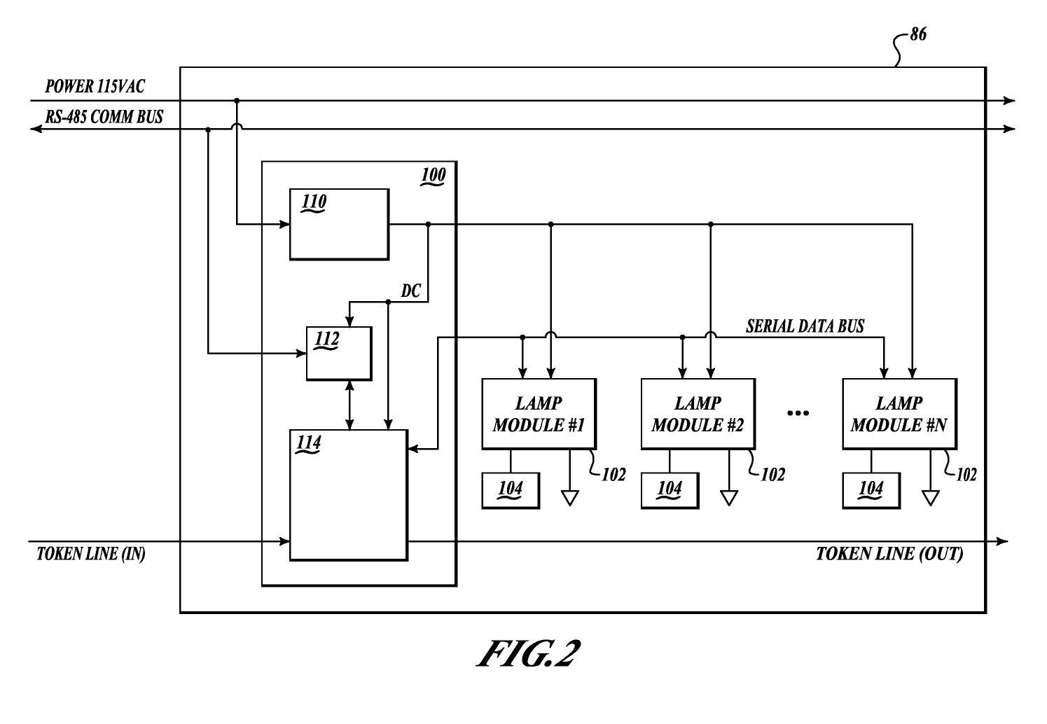

As shown in FIG. 2, each of the luminaires 86 may include a plurality of lamp modules 102. The luminaires 86 also include a control unit 100 having power conversion circuitry 110 that supplies power to each of the sub (lamp) modules 102, a databus interface 112 that is in communication with the RS-485 communication databus, and a light microcontroller 114. The light microcontroller 114 receives the token signal over the token line and address information from the RS-485 communication databus via the databus interface 112. Also, the databus delivers commands from the ZCU 82 for controlling operation of the luminaire 86 and the sub-modules 102.

In one embodiment, each of the lamp modules 102 are plugged into a location that has a unique set of address bits 104 in the form of plug-in pins. The light microcontroller 114 knows the location of each of the lamp modules 102 based on the address bits 104 of the pin that the lamp module 102 is attached to.

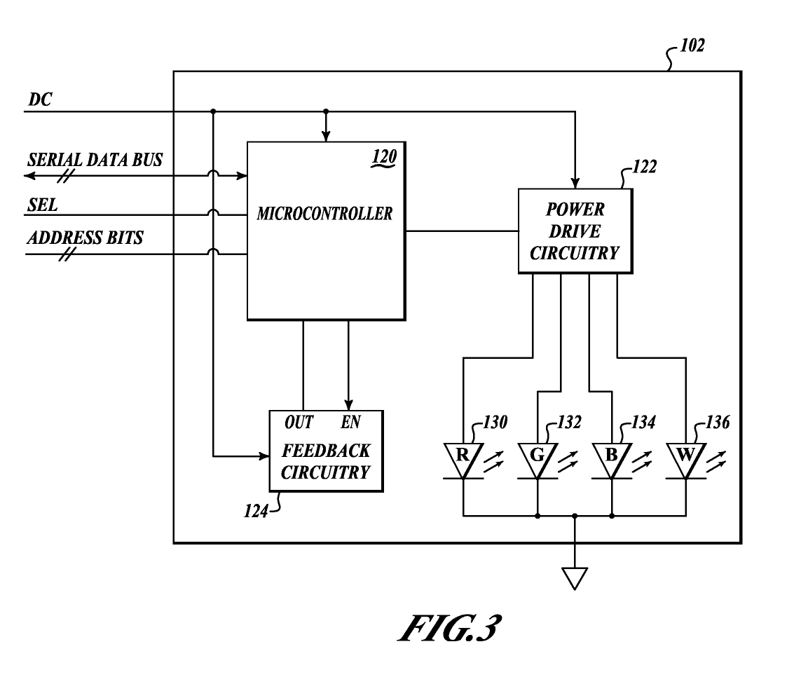

FIG. 3 illustrates an example of the lamp module 102. In one embodiment, the lamp module 102 includes an 8-bit microcontroller 120 with non-volatile memory. The lamp module 102 also includes power drive circuitry 122 and in one embodiment an optical intensity feedback circuit 124. The power drive circuitry 122 controls operation of one of a plurality of light emitting devices (LEDs), such as a red R LED 130, a green G LED 132, a blue B LED 134, and a white W LED 136 with a control signal. Other LED or color configurations may be used. The optical intensity feedback circuit 124 is controlled by an EN (enable) signal sent from the microcontroller 120. Results from the optical intensity feedback circuit 124 are sent back to the microcontroller 120 for storage and/or delivery back to the luminaire 86 or ZCU 82.

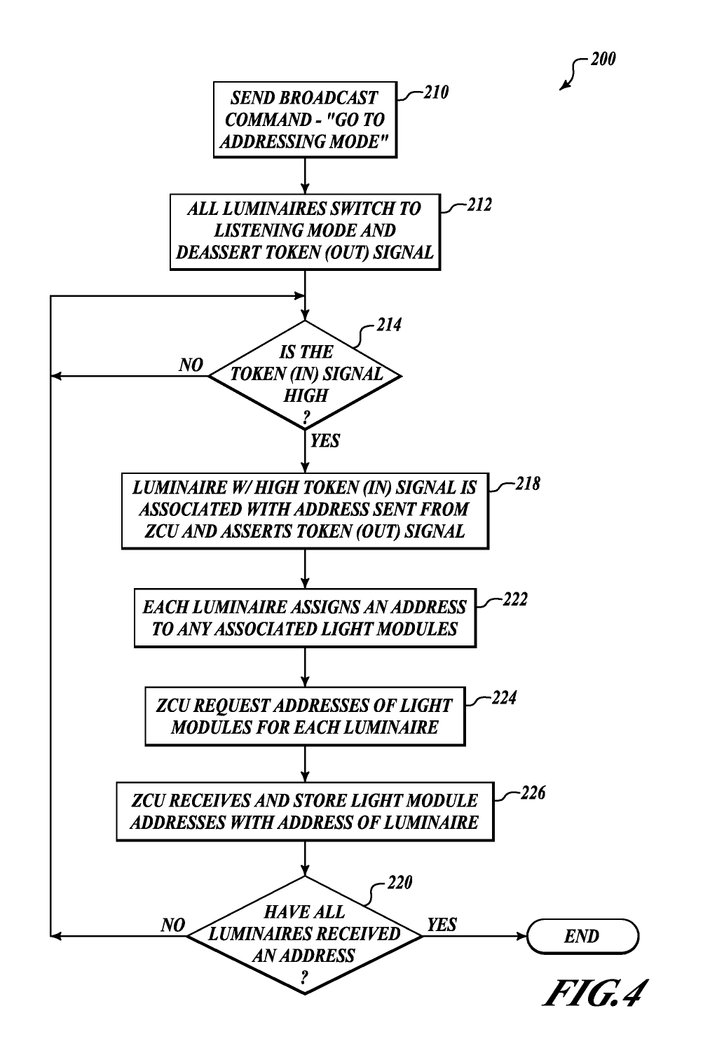

FIG. 4 illustrates an example process 200 for assigning addresses to the luminaires 86 of FIG. 1 and the lamp modules 102 shown in FIG. 2. First at a block 210, the ZCU 82 broadcasts over the databus a command message instructing the luminaires 86 to go into an addressing mode of operation. At a block 212, all the luminaires 86 that receive the broadcast command from the ZCU 82 switch to a listening mode and deassert their token (out) signal. Next, at a decision block 214, each of the luminaires 86 determines if the token (in) signal they receive is high. If the token (in) signal is high, then at a block 218, the luminaire 86 is associated with an address that is sent over the databus by the ZCU 82. The luminaire 86 acknowledges that it received the address and has stored the address. The ZCU 82 then proceeds to address the next luminaire 86. The luminaire 86 then asserts token (out) signal to the next luminaire 86.

Next, at a decision block 220, the process 200 returns to complete the association of addresses with luminaires 86 if not all of the luminaires 86 have yet received an address. The associated address is stored with memory associated with the ZCU 82 as well as in memory of the light microcontroller 114 of the luminaires 86.

At a block 222, each of the luminaires 86 assigns an address to any associated lamp module 102. This can be done physically by pin connection layout using plug-in pins 104 or it can be done similar to how the luminaires 86 get assigned an address (using a token signal, see above).

Next at a block 224, the ZCU 82 sends out a request to the luminaires 86 for information regarding the addresses for lamp modules 102 that are associated with the luminaires 86. Next at a block 226, the ZCU 82 receives and stores lamp module address information with the already stored addresses for the associated luminaires.

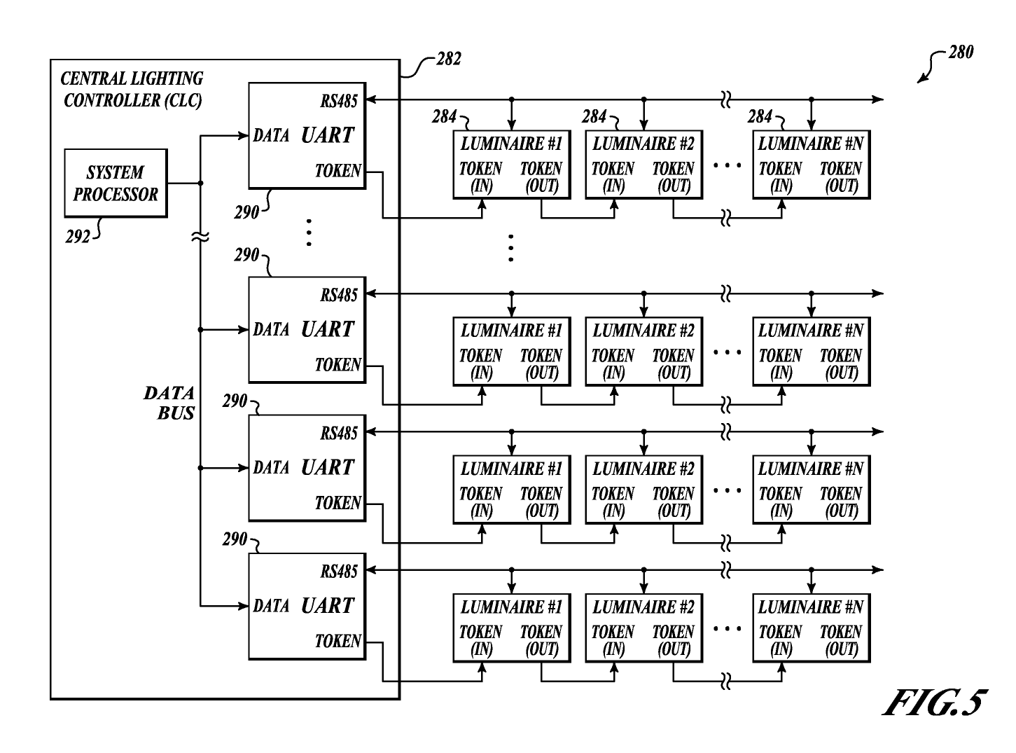

FIG. 5 illustrates another example implementation of the present invention. An aircraft 280 includes a central-lighting controller (CLC) 282 that is connected to a plurality of strings of luminaires 284. Each of the strings of luminaires 284 is coupled to a unique Universal Asynchronous Receiver Transmitter (UART) 290 located within the CLC 282. A system processor 292, also located within the CLC 282, is in data communication with each of the UARTs 290. The system processor 292 provides instructions to the UART 290 in order to selectively control each of the luminaires 282 within each of the strings as well as each of the lamp modules (not shown) located within each of the luminaires 284.

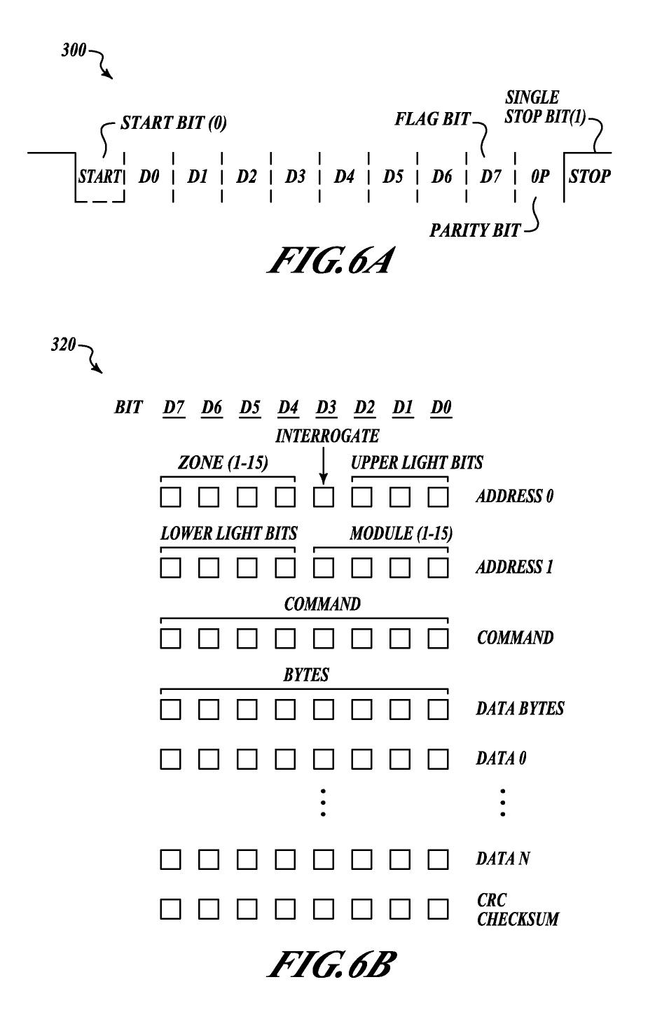

FIG. 6A illustrates an example serial transmission protocol 300 of instruction messages supplied by a ZCU 82 or similar device to the luminaires 86 or UARTs 290 for controlling luminaire operation and operation of any submodules of the luminaires.

FIG. 6B illustrates an example data packet 320 that has been sent in accordance with the protocol 300 shown in FIG. 6A. The data packet 320 includes addressing information in bytes Address 0 and 1, instruction information, and data integrity information.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for assigning addresses to one or more modules having one or more associated sub-modules, the method comprising:
(a) switching the one or more modules to an addressing mode of operation based on an address command and deasserting a token out signal;
(b) asserting a token in signal received by a first of the one or more modules;
(c) sending address information on a communication databus;
(d) recording the address information at the first module that has the received the asserted token in signal and has not asserted its token out signal;
(e) assigning address information to the associated sub-modules within the first module;
(f) sending the recorded address information and assigned sub-module address information to a master control unit;
(g) saving the sent address information and sub-module addresses at the master control unit and the associated module; and
(h) deasserting the token in signal received by the first module;
(i) asserting a token in signal at a next module;
(j) repeating (c)-(i) until a desired number of modules and associated sub-modules have recorded and assigned address information.

2. The method of claim 1, wherein (a)-(j) are performed automatically.

3. The method of claim 2, wherein the modules include luminaires and the sub-modules includes lamp components.

4. The method of claim 3, wherein (e) comprises:
plugging in the one or more sub-modules into one or more unique preaddressed receptacles; and
recording address information for the one or more sub-modules based on the plugged in location of the lamp module.

5. The method of claim 3, wherein at least one of the luminaires includes a control unit in data communication with the associated sub-modules and the master control unit.

6. The method of claim 5, further comprising:
generating at the master control unit illumination instructions based on operation of a user control device associated with the master control unit and the saved address information;
sending the illumination instructions to at least one of the luminaires; and
controlling operation of the luminaires and sub-modules based on the sent illumination instructions.

7. A system for assigning addresses to system components, the system comprising:
a communication databus;
one or more modules in data communication with the communication databus, at least one of the modules comprising:
one or more sub-modules;
a control unit in data communication with the communication databus and with the sub-modules, the control unit comprising:
a first component for controlling operation of the sub-modules based on data received over the communication databus and the status of a token in signal and for controlling the status of a token out signal; and
a second component for controlling status of a token out signal that is received by a next module; and
a master control unit in data communication with the modules via the communication databus, the master control unit comprising:
a memory; and
a processing device in data communication with the memory and the communication databus, the processing device comprising:
a first component for sending an address command to the one or more modules over the communication databus, wherein the address command instructs the one or more modules to switch to an addressing mode of operation;
a second component for sending an asserted token signal to a first one of the one or more modules; and
a third component for sending address information on the communication databus,
wherein the one or more modules record the address information off of the communication databus based on the token in signal, assign address information to the associated sub-modules, send the recorded and assigned address information to the master control unit, and assert the token out signal,
wherein the master control unit saves the sent address information in the memory,
wherein the system repeats until a desired number of modules and associated sub-modules have recorded and assigned address information.

8. The system of claim 7, wherein the system operates automatically.

9. The system of claim 8, wherein the modules include luminaires and the sub-modules include lamp units.

10. The system of claim 9, wherein one of the luminaires includes two or more locations having a unique configuration of one or more plug-in pins, each of the locations being associated with an address at the luminaire based on the pin configuration, wherein the lamp modules are attached to a respective configuration of plug-in pins.

11. The system of claim 9, wherein the master control unit includes a user control device for controlling operation of the luminaires and the lamp units,
the processing device comprises:
a fourth component for generating illumination instructions based on operation of the user control device and the saved address information; and
a fifth component for sending the illumination instructions to at least one of the luminaires,
wherein the control unit of the luminaires controls operation of the associated lamp units based on the sent illumination instructions.
